(19) United States
(12) Patent Application Publication
(10) Pub. No.: US 2024/0183527 A1
(43) Pub. Date: Jun. 6, 2024

(54) Steam Separator and Boiling Water Reactor Including Same

(71) Applicant: Hitachi-GE Nuclear Energy, Ltd., Ibaraki (JP)

(72) Inventors: Kiyoshi FUJIMOTO, Tokyo (JP); Naoyuki ISHIDA, Tokyo (JP)

(21) Appl. No.: 18/520,976

(22) Filed: Nov. 28, 2023

(30) Foreign Application Priority Data
Dec. 6, 2022 (JP) 2022-195103

(51) Int. Cl. F22B 37/30; F22B 37/40; F22B 37/50

(52) U.S. Cl. CPC F22B 37/306; F22B 37/40; F22B 37/50

(57) ABSTRACT

In a steam separator including a plurality of stages of separating mechanisms, a separating mechanism in a second or subsequent stage includes vertical plates and that divide a second stage annular flow passage or a third stage annular flow passage in a circumferential direction, and eliminate a swirl component of a mixed flow continuously occurring from a second stage inner cylinder or a third stage inner cylinder to the second stage annular flow passage or the third stage annular flow passage.

### CROSS-REFERENCE TO RELATED APPLICATION

The present application claims priority from Japanese application JP2022-195103, filed on Dec. 6, 2022, the content of which is hereby incorporated by reference into this application.

### BACKGROUND OF THE INVENTION

### 1. Field of the Invention

The present invention relates to a steam separator and a boiling water reactor including the same, and particularly to a steam separator disposed above a reactor core in order to separate a mixed fluid of steam generated in the reactor core and water into the steam and the water, and a boiling water reactor including the same.

### 2. Description of the Related Art

As an example of a steam separator that, by using a simple structure, can reduce an amount of droplets accompanying steam outside the steam separator, and reduce a carry-over under a condition of high quality while suppressing an increase in the ventilation resistance of the steam and a boiling water reactor including the same, Japanese Patent No. 5562908 describes a steam separator including at least: a stand pipe that guides a gas-liquid two-phase flow upward from below; a diffuser that communicates with an upper side end surface of the stand pipe to form a flow passage, and expands a flow passage cross-sectional area toward an upward direction more than a flow passage cross-sectional area of the upper side end surface; a first stage inner cylinder that communicates with an upper side end surface of the diffuser to form a flow passage; a first stage outer cylinder that is concentrically spaced from and surrounds the first stage inner cylinder to form an annular flow passage; a first stage annular plate that covers an inner circumferential edge of an upper side end surface of the first stage outer cylinder, and forms a circular hole having a smaller diameter than the first stage inner cylinder; a first stage pickoff ring that is erected downward in a tubular shape from an inner circumferential edge forming the circular hole of the first stage annular plate, and forms the circular hole as a flow passage to a second stage inner cylinder; the second stage inner cylinder that is installed on the first stage annular plate to form a flow passage; a second stage outer cylinder that is concentrically spaced from and surrounds the second stage inner cylinder to form an annular second stage discharge flow passage; a second stage annular plate that covers an inner circumferential edge of an upper side end surface of the second stage outer cylinder, and forms a circular hole having a smaller diameter than the second stage inner cylinder; a third stage inner cylinder that is installed on the second stage annular plate to form a flow passage; and a second stage pickoff ring that is erected downward in a tubular shape from an inner circumferential edge forming the circular hole of the second stage annular plate, and forms the circular hole as a flow passage to the third stage inner cylinder, and including a swirler that includes a hub passing through an axial center of the flow passage of the gas-liquid two-phase flow and a plurality of swirl vanes attached radially with the hub as a center, the swirl vanes having an inner edge fixed to the hub in a radial direction of the swirl vanes and having an outer edge fixed to an inner wall of the diffuser or an inner wall of the first stage inner cylinder in the radial direction of the swirl vanes, the second stage outer cylinder being provided with a second stage separated water discharge port that discharges water flowing into the second stage discharge flow passage and a second stage steam discharge port that discharges steam, the second stage steam discharge port being disposed at a higher position than the second stage separated water discharge port, a projection that projects to the second stage discharge flow passage being provided along an edge of the second stage steam discharge port, a distal end of the projection being bent in a direction of not closing the flow passage of the second stage steam discharge port to form a projection groove as a groove-shaped flow passage between the distal end of the projection and the second stage outer cylinder.

### PRIOR ART DOCUMENT

### [Patent Document]

[Patent Document 1] Japanese Patent No. 5562908

### SUMMARY OF THE INVENTION

In an ordinary boiling water reactor, a plurality of steam separators are installed above a reactor core in order to separate a mixed fluid of steam generated in the reactor core and water into the steam and the water. In this steam separator, a swirler (swirl vanes) within a diffuser imparts a swirl speed to the mixed fluid of the steam and the water. The mixed fluid is thus separated into the steam and the water by using a gas-liquid density difference due to a centrifugal force.

The separated water descends through an annular flow passage between an inner cylinder and an outer cylinder from a space within the inner cylinder of the steam separator, is drained from a discharge port below the outer cylinder of the steam separator, returns to a downcomer, and is sent to the reactor core again by a recirculation pump. Meanwhile, the separated steam is discharged from a central flow passage of the steam separator to the outside of the steam separator, and flows into a steam dryer. After a moisture content is removed from the steam, the steam is sent to a turbine. As a result of the above, an efficient electric power generation is realized by removing the moisture content as much as possible from the steam including the moisture content which steam is generated in the reactor core.

Further, as a method for realizing an efficient electric power generation, it is effective to increase an amount of generated steam by increasing the ratio of a steam flow rate to a total flow rate of the steam and the water at the outlet of the reactor core (which ratio will hereinafter be referred to as quality).

When the quality of the mixed fluid of the steam and the water flowing in the steam separator is changed, gas-water separation performance is also changed. In general, when the quality is increased, and thereby the amount of generated steam is increased, the swirl speed imparted to the two-phase flow by the swirler is increased, the centrifugal force is thereby increased, and consequently gas-water separation performance is improved.

In the following, as an example, a steam separator of a three-stage type used in an advanced boiling water reactor (hereinafter referred to as an ABWR) will be described.

In the steam separator used in the ABWR, separated water in which steam is hardly mixed is drained from a downward discharge port in an annular flow passage between a first stage inner cylinder and a first stage outer cylinder. In addition, separated water and steam are discharged from discharge ports provided below respective outer cylinders in a second stage and a third stage from the bottom of the steam separator.

Here, when the amount of generated steam is increased at the outlet of the reactor core, that is, when a steam flow rate is increased at an inlet of the steam separator, the flow rate of the steam separated by a pickoff ring and flowing into an annular flow passage from each of inner cylinders in the second stage and the third stage from the bottom of the steam separator, that is, a steam speed is increased.

The water separated by the pickoff rings in the second stage and the third stage from the bottom of the steam separator flows down as a liquid film on the external surfaces of the inner cylinders and the inner surfaces of the outer cylinders within the annular flow passages, or is present as droplets and is discharged from the discharge ports together with the steam. When the steam speed is increased, there is a possibility of the steam rippling the surfaces of liquid films flowing down, involving droplets formed by tearing off the edges of the waves, being discharged from the discharge ports as it is, rising through a narrow flow passage between a plurality of steam separators, and flowing into the steam dryer as the steam having a high moisture content.

Japanese Patent No. 5562908 describes the installation of L-shaped structures along the edges of the discharge ports for the steam as means for preventing the liquid films from accompanying the steam, the liquid films being present and flowing down within the annular flow passages between the inner cylinders and the outer cylinders in the second stage and the third stage from the bottom of these steam separators.

However, in Japanese Patent No. 5562908 adopting the above-described L-shaped structures, it is necessary to install the L-shaped structures within the narrow annular flow passages between the inner cylinders and the outer cylinders in the second stage and the third stage from the bottom of the steam separator having a plurality of stages of separating mechanisms. There is thus room for an improvement in workability. On the other hand, clearances for the steam to flow at positions where the L-shaped structures are installed need to be secured. However, there is a fear of increasing the steam speed when the clearances are narrow.

In addition, as for the water and the steam separated by the pickoff rings within the inner cylinders in the second stage and the third stage from the bottom of the steam separator having the plurality of stages of separating mechanisms, the separated water and the steam after passing through the pickoff rings are present in a state of a churned flow or an annular dispersed flow within the annular flow passages, and thus a large amount of droplets is present in the steam.

Further, when the steam speed is increased, there is a fear of the steam rippling the surfaces of the liquid films flowing down within the annular flow passages, tearing off the edges of the waves to form droplets, and thus increasing the droplets accompanying the steam.

The present invention has been made in view of the above-described points. It is an object of the present invention to provide a steam separator that, by using a simple structure, can decrease an amount of droplets accompanying steam within an annular flow passage in a second or subsequent stage from the bottom of the steam separator having a plurality of stages of separating mechanisms, and reduce a carry-over under a condition of high quality, and a boiling water reactor including the same.

The present invention includes a plurality of means for solving the above-described problems. To cite an example of the means, there is provided a steam separator including a plurality of stages of separating mechanisms, a separating mechanism in a first stage from a bottom including a stand pipe that guides a mixed fluid of steam generated by a reactor core and water upward from below, a diffuser that communicates with an upper side end surface of the stand pipe to form a flow passage, and expands a flow passage cross-sectional area toward an upward direction more than a flow passage cross-sectional area of the upper side end surface, a first stage inner cylinder that communicates with an upper side end surface of the diffuser to form a flow passage, a swirler that includes a hub passing through an axial center of the flow passage of a mixed flow of the steam and the water and a plurality of swirl vanes attached radially with the hub as a center, the swirl vanes having an inner edge fixed to the hub in a radial direction of the swirl vanes, and having an outer edge fixed to an inner wall of the diffuser or an inner wall of the first stage inner cylinder in the radial direction of the swirl vanes, a first stage outer cylinder that forms a first stage discharge port in a lower part of a first stage annular flow passage formed so as to be concentrically spaced from and surround the first stage inner cylinder, a first stage annular plate that covers an upper side surface of the first stage outer cylinder, and forms a circular hole having a smaller diameter than the first stage inner cylinder, and a first stage pickoff ring that is extended downward in a tubular shape from an inner circumferential edge forming the circular hole of the first stage annular plate, and forms the circular hole as a short flow passage to a second stage inner cylinder, and a separating mechanism in a second or subsequent stage from the bottom including a second or subsequent stage inner cylinder that is installed on the annular plate in a preceding stage to form a flow passage, a second or subsequent stage outer cylinder that forms a second or subsequent stage discharge port in a lower part of a second or subsequent stage annular flow passage formed so as to be concentrically spaced from and surround the second or subsequent stage inner cylinder, a second or subsequent stage annular plate that covers an upper side surface of the second or subsequent stage outer cylinder, and forms a circular hole having a smaller diameter than the second or subsequent stage inner cylinder, and a second or subsequent stage pickoff ring that is extended downward in a tubular shape from an inner circumferential edge forming the circular hole of the second or subsequent stage annular plate, and forms the circular hole as a short flow passage to an inner cylinder in a next or subsequent stage or an outlet flow passage, the separating mechanism in the second or subsequent stage including a vertical plate that divides the second or subsequent stage annular flow passage in a circumferential direction and eliminates a swirl component of the mixed flow continuously occurring from the second or subsequent stage inner cylinder to the second or subsequent stage annular flow passage.

According to the present invention, by using a simple structure, it is possible to decrease an amount of droplets accompanying the steam within the annular flow passage in the second or subsequent stage from the bottom of the steam separator including the plurality of stages of the separating mechanisms, and reduce a carry-over under a condition of high quality. Problems, configurations, and effects other than those described above will be made clear by the following description of embodiments.

### BRIEF DESCRIPTION OF THE DRAWINGS

FIG. 1 is a vertical sectional view illustrating a general structure of a boiling water reactor to which a steam separator according to the present invention is applied;

FIG. 2 is a vertical sectional view illustrating a steam separator according to a first embodiment, and is a view taken in the direction of arrows of a line A-A in FIG. 3 to be described below;

FIG. 3 is a horizontal sectional view illustrating a plurality of steam separators according to the first embodiment;

FIG. 4 is a vertical sectional view illustrating a side above a second stage in the steam separator according to the first embodiment;

FIG. 5 is a horizontal section illustrating the steam separator according to the first embodiment, and is a view taken in the direction of arrows of a line B-B in FIG. 4;

FIG. 6 is a detailed view of a D part of FIG. 5 in the horizontal section illustrating the steam separator according to the first embodiment;

FIG. 7 is a developed view illustrating the steam separator according to the first embodiment when an outer circumference side is viewed from the outer surface of an inner cylinder in the second stage or a third stage;

FIG. 8 is a detailed view of a C part of FIG. 4 in a discharge port of the steam separator according to the first embodiment;

FIG. 9 is a diagram illustrating a state in which vertical plates of the steam separator according to the first embodiment are installed on the inner surface of a second stage outer cylinder;

FIG. 10 is a diagram illustrating a state in which the vertical plates of the steam separator according to the first embodiment are installed on the outer surface of a second stage inner cylinder;

FIG. 11 is a horizontal sectional view illustrating a modification of the steam separator according to the first embodiment;

FIG. 12 is a detailed view of an E part of FIG. 11 in a horizontal section illustrating the modification of the steam separator according to the first embodiment;

FIG. 13 is a vertical sectional view illustrating a steam separator according to a second embodiment;

FIG. 14 is a view taken in the direction of arrows of a line F-F in FIG. 13 in a horizontal section illustrating the steam separator according to the second embodiment;

FIG. 15 is a view taken in the direction of arrows of a line G-G in FIG. 13 in a horizontal section illustrating the steam separator according to the second embodiment;

FIG. 16 is a developed view illustrating the steam separator according to the second embodiment when an outer circumference side is viewed from the outer surface of an inner cylinder in a second stage or a third stage;

FIG. 17 is an enlarged view of an H part in FIG. 13 in details of a discharge port of the steam separator according to the second embodiment;

FIG. 18 is a detailed view of a swirling flow within an annular flow passage in the second stage of the steam separator according to the second embodiment;

FIG. 19 is a detailed view of a swirling flow within an annular flow passage in the third stage of the steam separator according to the second embodiment;

FIG. 20 is a horizontal sectional view illustrating a first modification of the steam separator according to the second embodiment;

FIG. 21 is a developed view when an outer circumference side is viewed from the outer surface of an inner cylinder in a second stage or a third stage of the first modification of the steam separator according to the second embodiment;

FIG. 22 is a vertical sectional view illustrating a second modification of the steam separator according to the second embodiment;

FIG. 23 is a developed view when the inner surface of an outer cylinder is viewed from the outer surface of an inner cylinder in a second stage of the second modification of the steam separator according to the second embodiment;

FIG. 24 is a developed view when the inner surface of an outer cylinder is viewed from the outer surface of an inner cylinder in a third stage of the second modification of the steam separator according to the second embodiment;

FIG. 25 is a vertical sectional view illustrating a steam separator according to a third embodiment;

FIG. 26 is a view taken in the direction of arrows of a line L-L in FIG. 25 in a horizontal section illustrating the steam separator according to the third embodiment; and

FIG. 27 is a view taken in the direction of arrows of a line M-M in FIG. 25 in a horizontal section illustrating the steam separator according to the third embodiment.

### DESCRIPTION OF THE PREFERRED EMBODIMENTS

Embodiments of a steam separator and a boiling water reactor including the same according to the present invention will hereinafter be described with reference to the drawings. Incidentally, in the drawings used in the present specification, identical or corresponding constituent elements are identified by identical or similar reference numerals, and repeated description of these constituent elements may be omitted.

### First Embodiment

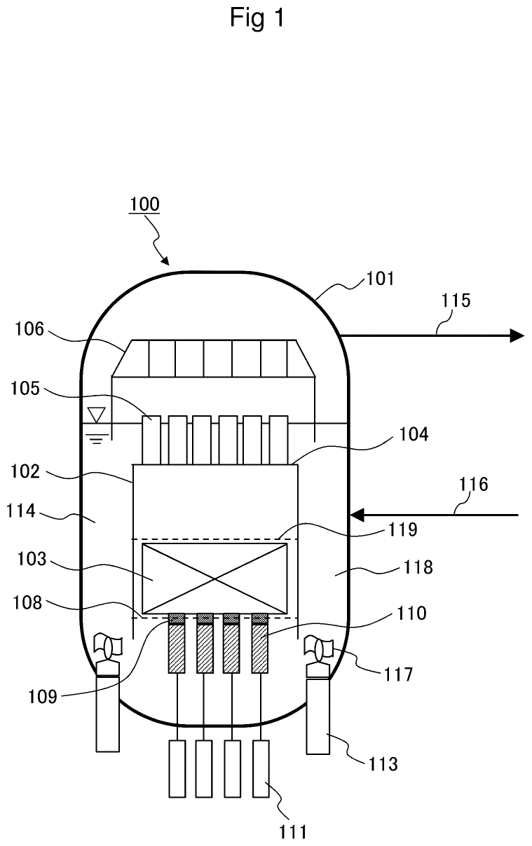

A first embodiment of the steam separator and the boiling water reactor including the same according to the present invention will be described with reference to FIGS. 1 to 12.

First, before the description of the steam separator according to the present embodiment, a general structure of the boiling water reactor to which the steam separator is applied will be described with reference to FIG. 1. FIG. 1 is a diagram illustrating a general configuration of an ABWR.

In an advanced boiling water reactor 100 illustrated in FIG. 1, a reactor core shroud 102 in a cylindrical shape is provided within a nuclear reactor pressure vessel 101. A reactor core 103 loaded with a plurality of fuel assemblies is installed within the reactor core shroud 102.

An upper portion grid plate 119 is installed at an upper end portion of the reactor core within the reactor core shroud 102. A reactor core support plate 108 is installed at a lower end portion of the reactor core within the reactor core shroud 102. In addition, a plurality of fuel support fittings 109 are installed on the reactor core support plate 108.

In addition, control rod guide tubes 110 that allow a plurality of cross-shaped control rods to be inserted into the reactor core 103 are provided within the nuclear reactor pressure vessel 101 in order to control nuclear reaction of the fuel assemblies. Control rod driving mechanisms 111 are provided within a control rod driving mechanism housing installed below a bottom portion of the nuclear reactor pressure vessel 101. The cross-shaped control rods are coupled to the control rod driving mechanisms 111.

A coolant 118 that flows into the inside of the reactor core 103 is heated by the nuclear reaction of the fuel assemblies, thereby becomes a mixed flow of steam and water, and then flows into steam separators 105 arranged above the reactor core 103. A swirler 122 present within the steam separator 105 imparts a swirl speed to the mixed flow that has flowed into the steam separator 105. A centrifugal force acts on the mixed flow due to the swirl speed. The mixed flow is thus separated into the water and the steam due to a density difference between the water and the steam. The water flows as the coolant 118 to a downcomer 114 again.

Meanwhile, the steam flows into a steam dryer 106, and is further dried therein. A moisture content is thereby removed from the steam. Thus, electric power generation is performed by sending the steam whose moisture content is reduced to 0.1 percent by weight or less to a turbine (not illustrated) through a main steam pipe 115.

An internal pump 113 causes the coolant 118 flowing into the inside of the nuclear reactor pressure vessel 101 from a water supply pipe 116 via a steam condenser or the like (not illustrated) to flow downward within the downcomer 114 that is formed between the nuclear reactor pressure vessel 101 and the reactor core shroud 102 and through which the water separated by the steam separator 105 circulates. Thus, the internal pump 113 makes the coolant 118 forcedly circulate to the reactor core 103 in order to efficiently cool the heat generated in the reactor core 103. Incidentally, a jet pump can be used in place of the internal pump 113.

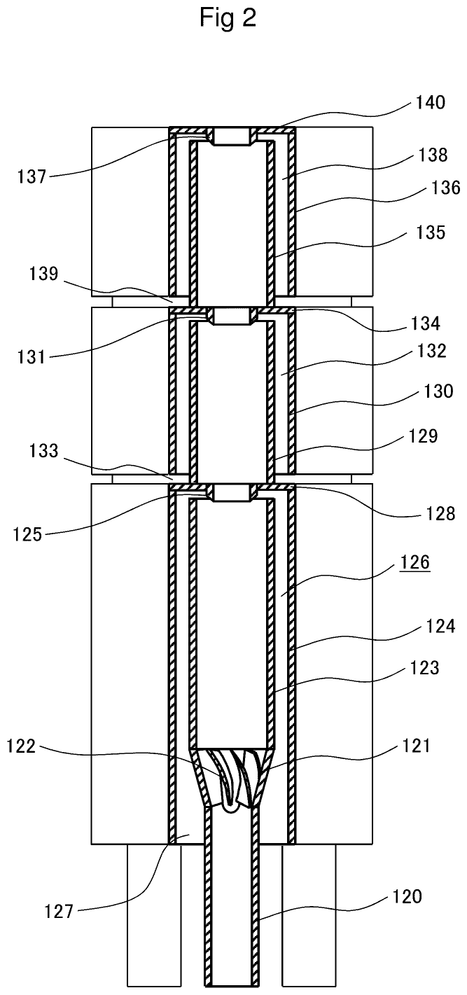

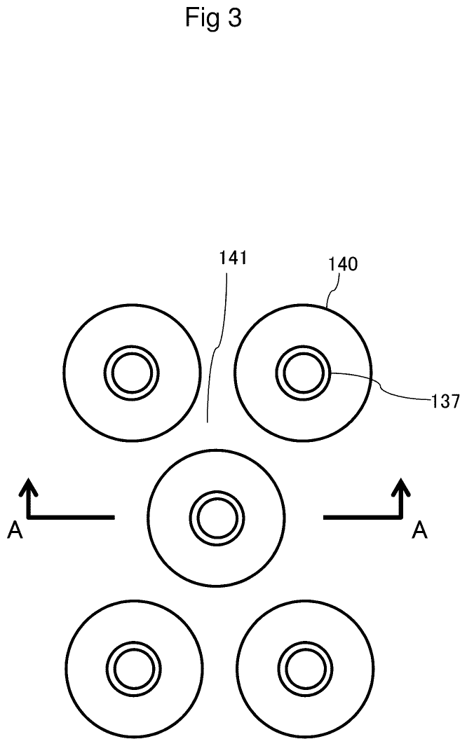

Next, a configuration of the steam separator will be described with reference to FIG. 2 and FIG. 3. The present invention is targeted for steam separators having two stages or more of separating mechanisms. FIG. 2 illustrates a steam separator having three stages of separating mechanisms.

A steam separator 105 illustrated in FIG. 2 includes three stages of separating mechanisms.

The separating mechanism in a first stage provided in a lowermost part in a vertical direction includes a stand pipe 120, a diffuser 121, a first stage inner cylinder 123, a swirler 122, a first stage outer cylinder 124, a first stage annular plate 128, and a first stage pickoff ring 125.

The stand pipe 120 guides, upward from below, a mixed fluid of steam generated by the reactor core 103 and water. The diffuser 121 communicates with an upper side end surface of the stand pipe 120 to form a flow passage, and expands a flow passage cross-sectional area toward an upward direction more than the flow passage cross-sectional area of the upper side end surface. The first stage inner cylinder 123 communicates with an upper side end surface of the diffuser 121 to form a flow passage. The swirler 122 includes a hub passing through an axial center of the flow passage of the mixed flow of the steam and the water and a plurality of swirl vanes attached radially with the hub as a center, the swirl vanes having an inner edge fixed to the hub in a radial direction of the swirl vanes and having an outer edge fixed to an inner wall of the diffuser 121 or an inner wall of the first stage inner cylinder 123 in the radial direction of the swirl vanes. The first stage outer cylinder 124 forms a first stage discharge port 127 in a lower part of a first stage annular flow passage 126 formed so as to be concentrically spaced from and surround the first stage inner cylinder 123. The first stage annular plate 128 covers an upper side surface of the first stage outer cylinder 124, and forms a circular hole having a smaller diameter than the first stage inner cylinder 123. The first stage pickoff ring 125 is extended downward in a tubular shape from an inner circumferential edge forming the circular hole of the first stage annular plate 128, and forms the circular hole as a short flow passage to a second stage inner cylinder 129.

The separating mechanism in a second stage from a bottom which separating mechanism is disposed directly above the separating mechanism in the first stage includes the second stage inner cylinder 129, a second stage outer cylinder 130, a second stage annular plate 134, and a second stage pickoff ring 131.

The second stage inner cylinder 129 is installed on the first stage annular plate 128 in a preceding stage to form a flow passage. The second stage outer cylinder 130 forms a second stage discharge port 133 in a lower part of a second stage annular flow passage 132 formed so as to be concentrically spaced from and surround the second stage inner cylinder 129. The second stage annular plate 134 covers an upper side surface of the second stage outer cylinder 130, and forms a circular hole having a smaller diameter than the second stage inner cylinder 129. The second stage pickoff ring 131 is extended downward in a tubular shape from an inner circumferential edge forming the circular hole of the second stage annular plate 134, and forms the circular hole as a short flow passage to a third stage inner cylinder 135.

The separating mechanism in a third stage from the bottom which separating mechanism is disposed directly above the separating mechanism in the second stage includes the third stage inner cylinder 135, a third stage outer cylinder 136, a third stage annular plate 140, and a third stage pickoff ring 137.

The third stage inner cylinder 135 is installed on the second stage annular plate 134 in the preceding stage to form a flow passage. The third stage outer cylinder 136 forms a third stage discharge port 139 in a lower part of a third stage annular flow passage 138 formed so as to be concentrically spaced from and surround the third stage inner cylinder 135. The third stage annular plate 140 covers an upper side surface of the third stage outer cylinder 136, and forms a circular hole having a smaller diameter than the third stage inner cylinder 135. The third stage pickoff ring 137 is extended downward in a tubular shape from an inner circumferential edge forming the circular hole of the third stage annular plate 140, and forms the circular hole as a steam separator outlet flow passage.

As illustrated in FIG. 3, a plurality of steam separators 105 are arranged at fixed intervals. The steam discharged from the second stage discharge port 133 and the third stage discharge port 139 of each of the steam separators 105 rises through an inter steam separator flow passage 141, and flows into the steam dryer 106 above the steam separator 105.

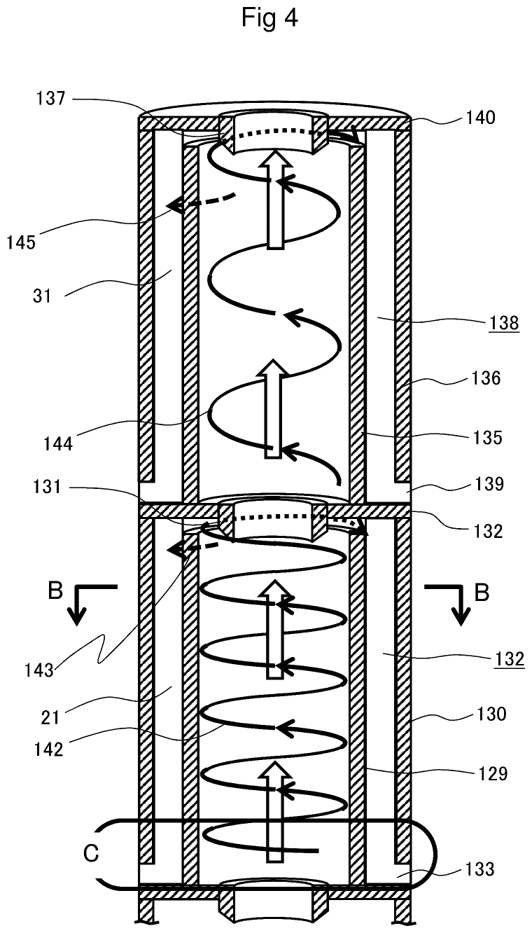

Next, a characteristic configuration of the steam separator 105 according to the first embodiment will be described with reference to FIGS. 4 to 8. FIG. 4 illustrates a structure of the separating mechanisms in the second stage and the third stage from the bottom of the steam separator.

Most characteristic constituent elements of the present invention are vertical plates 21 that divide the second stage annular flow passage 132 between the second stage inner cylinder 129 and the second stage outer cylinder 130 in a circumferential direction and eliminate a swirl component of a mixed flow continuously occurring from the second stage inner cylinder 129 to the second stage annular flow passage 132 and vertical plates 31 that divide the third stage annular flow passage 138 between the third stage inner cylinder 135 and the third stage outer cylinder 136 in the circumferential direction and eliminate a swirl component of a mixed flow continuously occurring from the third stage inner cylinder 135 to the third stage annular flow passage 138.

As illustrated in FIG. 4, a mixed fluid of steam and water, which mixed fluid is obtained by greatly reducing, within the first stage inner cylinder 123, the ratio of the water to a total flow rate of the mixed fluid of the steam and the water which mixed fluid flows into the steam separator 105, flows into the second stage inner cylinder 129.

Within the second stage inner cylinder 129, a swirling flow 142 generated by the swirl vanes below the first stage inner cylinder 123 is maintained and continued as it is. Therefore, also within the second stage inner cylinder 129, a centrifugal force acts on the mixed fluid of the steam and the water due to the swirling flow, the mixed fluid is separated into gas and water due to a gas-liquid density difference, and a liquid film is formed on the inner surface of the second stage inner cylinder 129 and moves upward.

The separated water flows from the second stage pickoff ring 131 to the second stage annular flow passage 132. On the other hand, the steam flows from the central flow passage of the second stage pickoff ring 131 to the inside of the third stage inner cylinder 135.

The separated water includes also steam. The separated water and the steam are present in a state of a churned flow or an annular dispersed flow within the second stage annular flow passage 132 after passing the second stage pickoff ring 131, and thus a large amount of droplets is present in the steam.

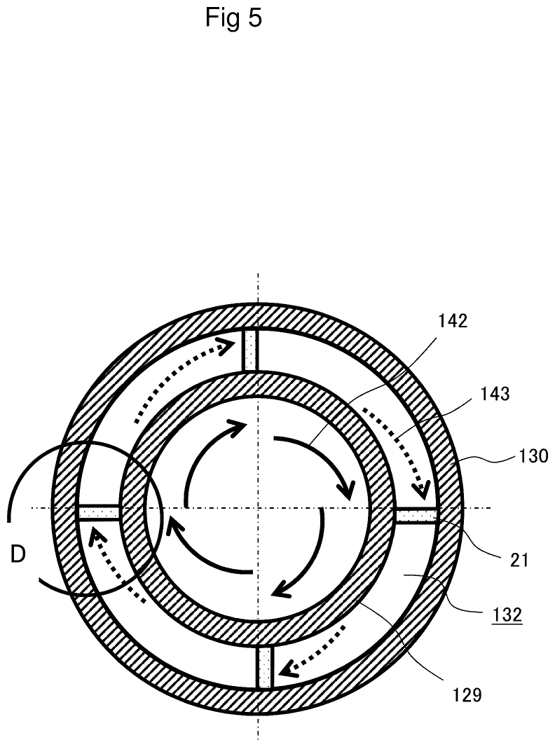

As indicated by broken lines in FIG. 4 and FIG. 5, the swirling flow 142 within the second stage inner cylinder 129 remains as a swirling flow 143 also within the second stage annular flow passage 132.

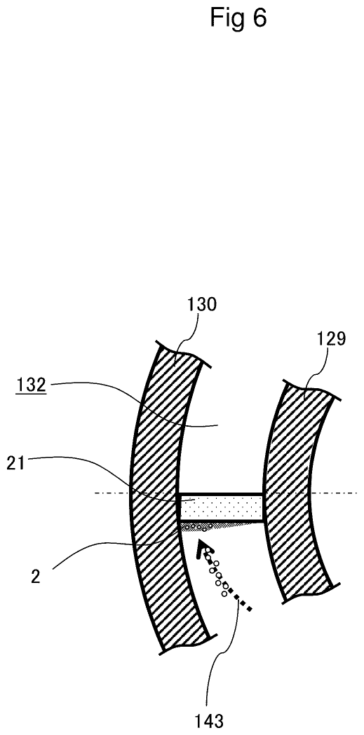

Accordingly, as illustrated in FIG. 6, the swirling flow 143 is used to make the steam including the droplets collide with the vertical plates 21 installed in the second stage annular flow passage 132 so as to extend to the second stage discharge port 133. A gas-water separation can be thereby performed.

The vertical plates 21 are connected to the inner surface of the second stage outer cylinder 130 or the outer surface of the second stage inner cylinder 129. Because water is expected to be collected on the inner circumferential side of the second stage outer cylinder 130 by the centrifugal force, the vertical plates 21 are more preferably installed so as to be in contact with the inner surface of the second stage outer cylinder 130. However, the vertical plates 21 may be in contact with either of the inner surface of the second stage outer cylinder 130 and the outer surface of the second stage inner cylinder 129.

In addition, the vertical plates 21 are installed such that end surfaces in the vertical direction of the vertical plates 21 are at an angle of 90 degrees with respect to the outer surface of the second stage inner cylinder 129 and the inner surface of the second stage outer cylinder 130.

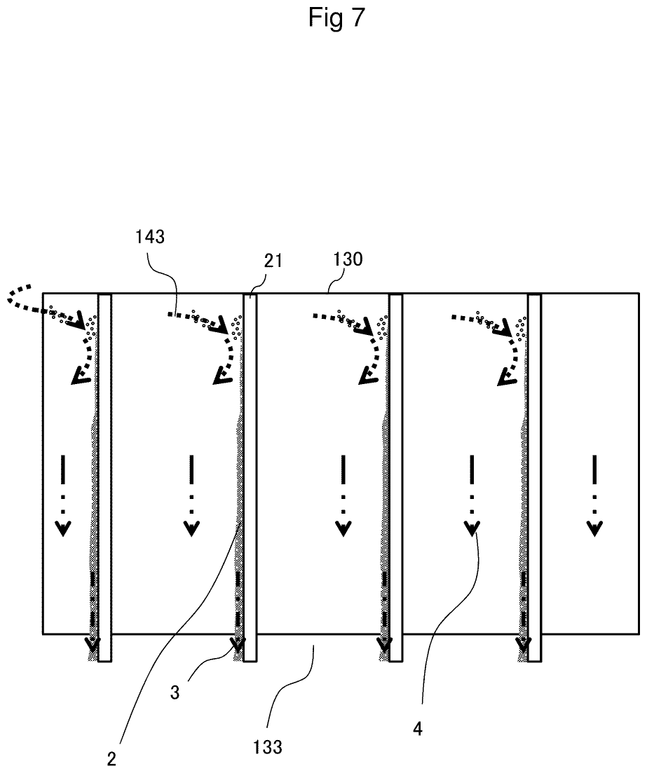

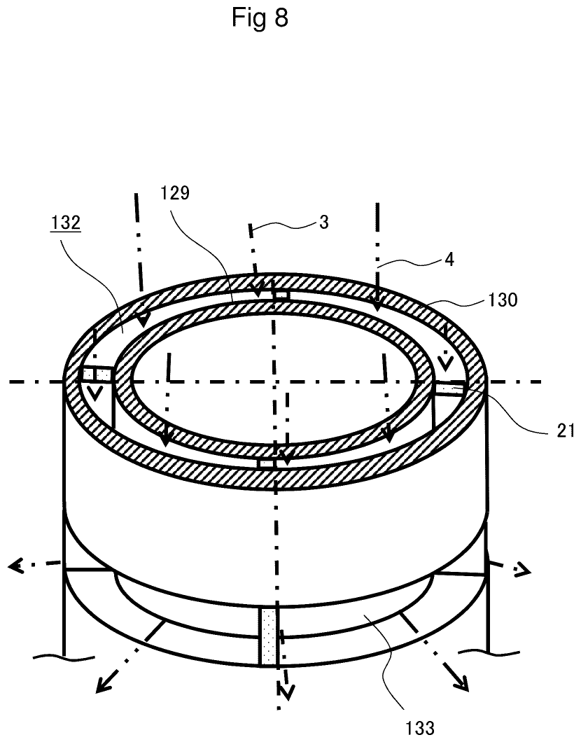

As illustrated in FIG. 7, the separated droplets become liquid films 2 on the vertical plates 21, and flow down as downward flows 3 due to gravity. In addition, the steam that collides with the vertical plates 21 and whose swirl component is lost becomes downward flows 4. At the second stage discharge port 133 below the second stage outer cylinder 130, as illustrated in FIG. 8, the liquid films 2 formed on the vertical plates 21 and flowing down flow out to the outside of the steam separator 105 as they are, and the downward flows 4 of the steam are also maintained, flow out to the outside of the steam separator 105, and flow into the steam dryer 106 above.

As described above, the vertical plates 21 enable the droplets in the steam to be separated, and enable the water and the steam to be discharged separately from each other at the second stage discharge port 133 of the second stage outer cylinder 130. Thus, a carry-over from the outside of the steam separator 105 to the steam dryer 106 can be reduced.

In addition, as illustrated in FIG. 4, the strength of a swirling flow 144 within the third stage inner cylinder 135 is weakened, but as in the second stage, a swirling flow 145 also remains in the third stage annular flow passage 138. Therefore, the swirling flow 145 is used to make the steam collide with the vertical plates 31 installed within the third stage annular flow passage 138 so as to extend to the third stage discharge port 139. A gas-water separation can be thereby performed.

The vertical plates 31 are also connected to the inner surface of the third stage outer cylinder 136 or the outer surface of the third stage inner cylinder 135. Because water is expected to be collected on the inner circumferential side of the third stage outer cylinder 136 by the centrifugal force, the vertical plates 31 are more preferably installed so as to be in contact with the inner surface of the third stage outer cylinder 136. However, the vertical plates 31 may be in contact with either of the inner surface of the third stage outer cylinder 136 and the outer surface of the third stage inner cylinder 135. Similarly, the vertical plates 31 are also installed such that end surfaces in the vertical direction of the vertical plates 31 are at an angle of 90 degrees with respect to the outer surface of the third stage inner cylinder 135 and the inner surface of the third stage outer cylinder 136.

These vertical plates 21 and 31 are in the shape of an L as viewed from a section in the vertical direction. It is preferable for each of the vertical plates 21 and 31 to extend to the outer circumferential surface of the second stage outer cylinder 130 or the third stage outer cylinder 136 from a viewpoint of guiding the liquid films to the outside of the separating mechanism. On the other hand, it is preferable for each of the vertical plates 21 and 31 to extend to be flush with the outer circumferential surface of the second stage outer cylinder 130 or the third stage outer cylinder 136 from a viewpoint of manufacturability, installation work, and the like.

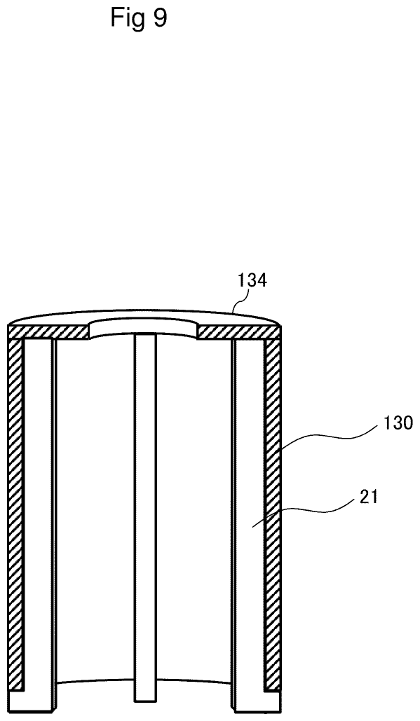

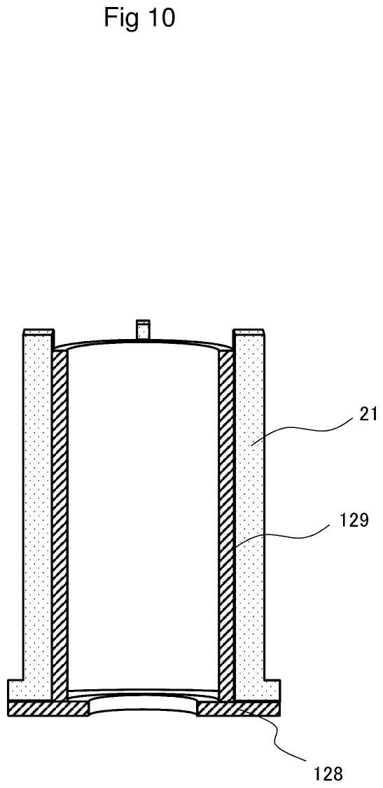

Next, a method of installing the vertical plates 21 and 31 into the steam separator 105 of the first embodiment will be described with reference to FIG. 9 and FIG. 10. The separating structure of the second stage from the bottom of the steam separator 105 will be described with reference to FIG. 9 and FIG. 10.

The present invention can be implemented easily by installing the vertical plates 21 on the inner surface of the second stage outer cylinder 130 as illustrated in FIG. 9 or installing the vertical plates 21 on the outer surface of the second stage inner cylinder 129 as illustrated in FIG. 10. Incidentally, the same is true for the separating structure of the third stage from the bottom of the steam separator.

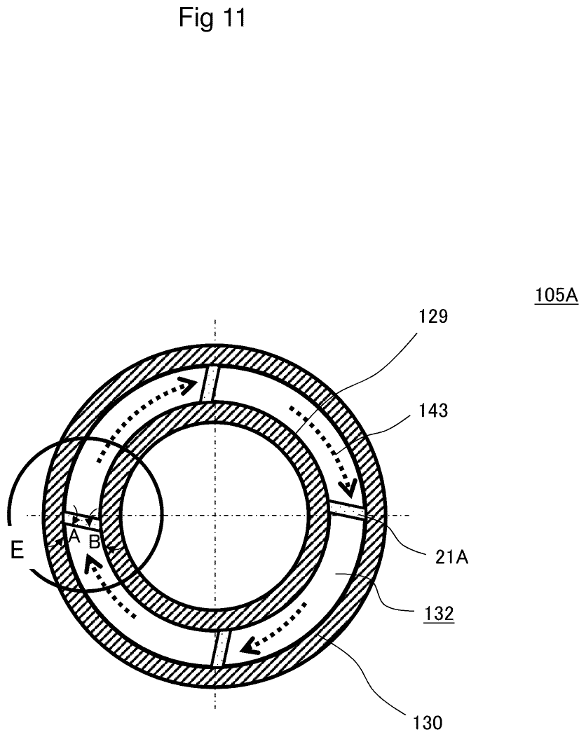

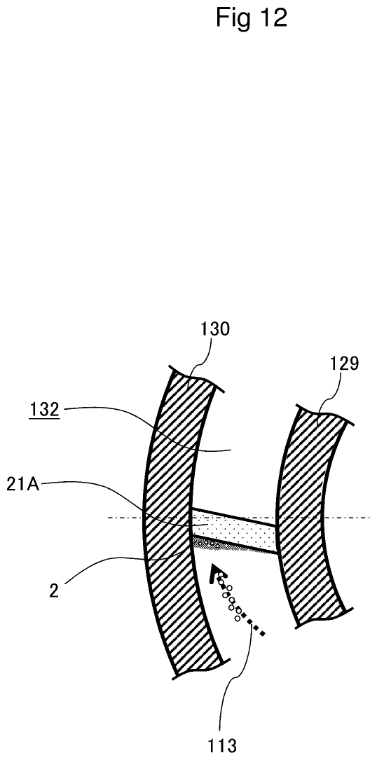

A modification of the steam separator of the first embodiment is illustrated in FIG. 11 and FIG. 12.

A characteristic configuration of the present example is the installation direction of the vertical plates installed within the annular flow passage.

As illustrated in FIG. 11, in a steam separator 105A according to the modification, end surfaces of vertical portions of vertical plates 21A are installed on or in proximity to the outer surface of the second stage inner cylinder 129 at an angle A smaller than 90 degrees with respect to the direction of the swirling flow 143 remaining within the second stage annular flow passage 132, or the end surfaces of the vertical portions of the vertical plates 21A installed within the second stage annular flow passage 132 are installed on or in proximity to the inner surface of the second stage outer cylinder 130 at an angle B larger than 90 degrees.

Consequently, as illustrated in FIG. 12, the droplets or the liquid films are collected easily in a space of an angle A portion, and the scattering of droplets at a time of collision of the steam with the vertical plates 21A can be reduced. Incidentally, there is no problem even when the angle A and the angle B are reversed. Further, the same function can be provided without any problem even at the angle A or the angle B.

Similarly, the end surfaces in the vertical direction of the vertical plates installed in the third stage annular flow passage 138 can also be installed at an angle smaller than 90 degrees or an angle larger than 90 degrees with respect to the outer surface of the third stage inner cylinder 135 and the inner surface of the third stage outer cylinder 136.

Effects of the present example will next be described.

In the steam separator 105 including the plurality of stages of the separating mechanisms according to the foregoing first embodiment of the present invention, the separating mechanism in the second or subsequent stage includes the vertical plates 21, 31, or 21A that divide the second stage annular flow passage 132 or the third stage annular flow passage 138 in the circumferential direction, and eliminate a swirl component of the mixed flow continuously generated from the second stage inner cylinder 129 or the third stage inner cylinder 135 to the second stage annular flow passage 132 or the third stage annular flow passage 138.

This enables a further gas-water separation to be performed by making the steam including the droplets collide with the vertical plates 21, 31, or 21A. It is thus possible to decrease an amount of droplets accompanying the steam as compared with the conventional technology, and reduce a carry-over under a condition of high quality where a steam flow rate is increased at a time of an output power enhancement. Therefore, a range of driving conditions of the nuclear reactor can be expanded.

In addition, the vertical plates 21 or 31 are installed such that the end surfaces in the vertical direction of the vertical plates 21 or 31 are at an angle of 90 degrees with respect to the outer surface of the second stage inner cylinder 129 or the third stage inner cylinder 135 and the inner surface of the second stage outer cylinder 130 or the third stage outer cylinder 136. The vertical plates 21 and 31 can therefore be installed easily.

Further, the vertical plates 21A are installed such that the end surfaces in the vertical direction of the vertical plates 21A are at an angle smaller than 90 degrees or an angle larger than 90 degrees with respect to the outer surface of the second stage inner cylinder 129 or the third stage inner cylinder 135 and the inner surface of the second stage outer cylinder 130 or the third stage outer cylinder 136. The vertical plates 21A can thereby reduce the scattering of droplets at a time of collision of the steam with the vertical plates 21A.

Further, the vertical plates 21, 31, or 21A are installed so as to be connected to the inner surface of the second stage outer cylinder 130 or the third stage outer cylinder 136 or the outer surface of the second stage inner cylinder 129 or the third stage inner cylinder 135. Thus, the vertical plates 21, 31, or 21A are fixed very easily, and it is possible to realize the discharging of liquid films more reliably by reducing a possibility of the liquid films staying between the second stage outer cylinder 130 or the third stage outer cylinder 136 and the second stage inner cylinder 129 or the third stage inner cylinder 135, or staying on the back surface sides or the like of the vertical plates 21, 31, or 21A.

In addition, the vertical plates 21, 31, or 21A extend to the second stage discharge port 133 or the third stage discharge port 139. The liquid films formed on the surface of the vertical plates 21, 31, or 21A can be thereby guided to the second stage discharge port 133 or the third stage discharge port 139, so that the discharging of the liquid films to the outside of the steam separator 105 or 105A can be performed more reliably.

### Second Embodiment

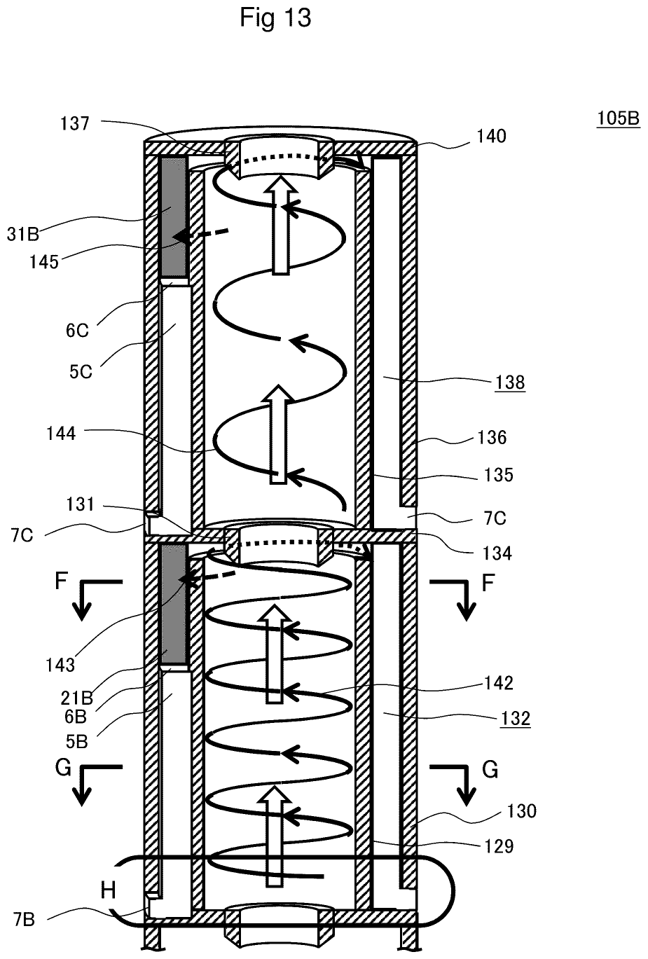

A steam separator and a boiling water reactor including the same according to a second embodiment of the present invention will be described with reference to FIGS. 13 to 24.

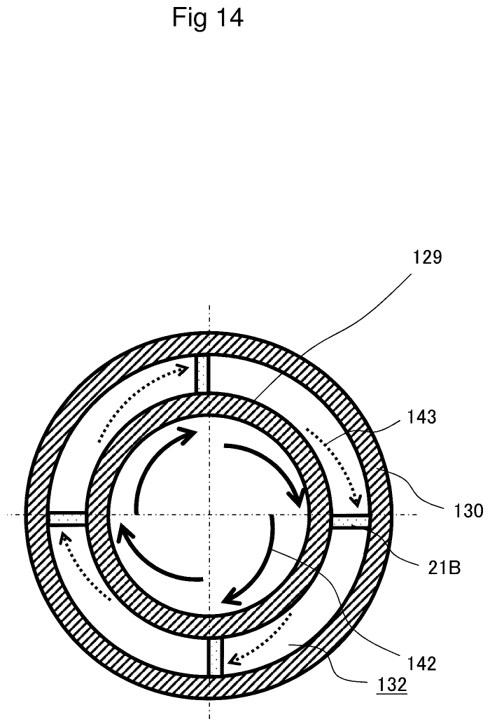

As with FIG. 4, FIG. 13 illustrates separating structures in the second stage and the third stage from the bottom of a steam separator 105B. As with FIG. 5 and the like, FIGS. 14 to 17 illustrate the separating structure in the second stage from the bottom of the steam separator 105B.

The steam separator 105B according to the present embodiment illustrated in FIGS. 13 to 17 further includes drainage forming plates 5B and 5C having a shorter length than vertical plates 21B and 31B at positions squarely facing surfaces of the vertical plates 21B and 31B with which surfaces a mixed flow collides, and the vertical plates 21B and 31B and the drainage forming plates 5B and 5C extend to the second stage discharge port 133 and the third stage discharge port 139. The steam separator 105B is thus configured to form each of drainage ports for draining water that adheres to the vertical plates 21B and 31B and flows down as liquid films and exhaust ports for steam.

As illustrated in FIG. 13 and FIG. 14, a flow until the steam including droplets collides with the vertical plates 21B installed within the second stage annular flow passage 132 is similar to the flow described with reference to FIG. 4 and FIG. 5.

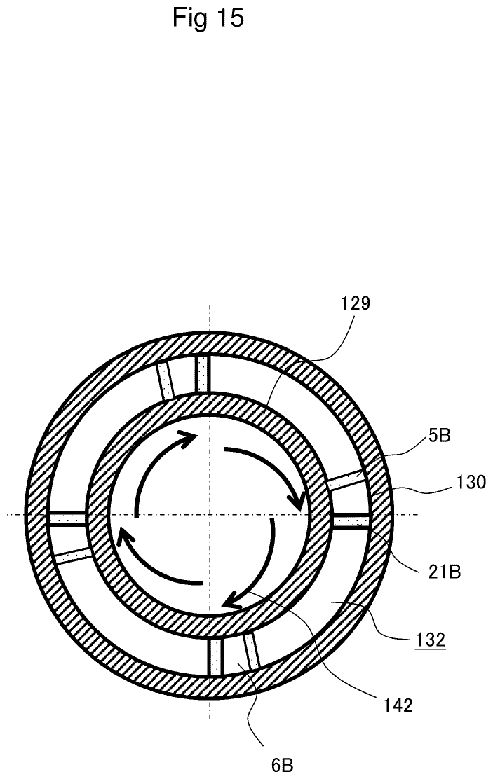

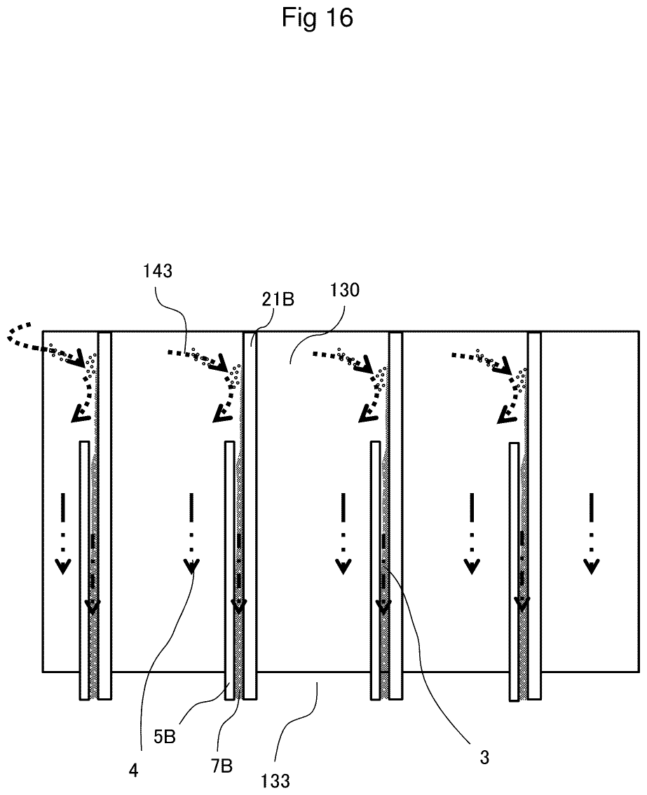

In the present embodiment, drainages are provided by installing the drainage forming plates 5B below the surfaces on which the steam collides with the vertical plates 21B. As illustrated in FIG. 15 and FIG. 16, the droplets adhering onto the vertical plates 21B become liquid films and flow down, but the liquid films do not come into contact with the descending steam while the liquid films flow down because drainages 6B are provided. It is consequently possible to further suppress the rippling of the surfaces of the liquid films due to the flow of the descending steam even at a time of an output power enhancement in which the steam flow rate is increased.

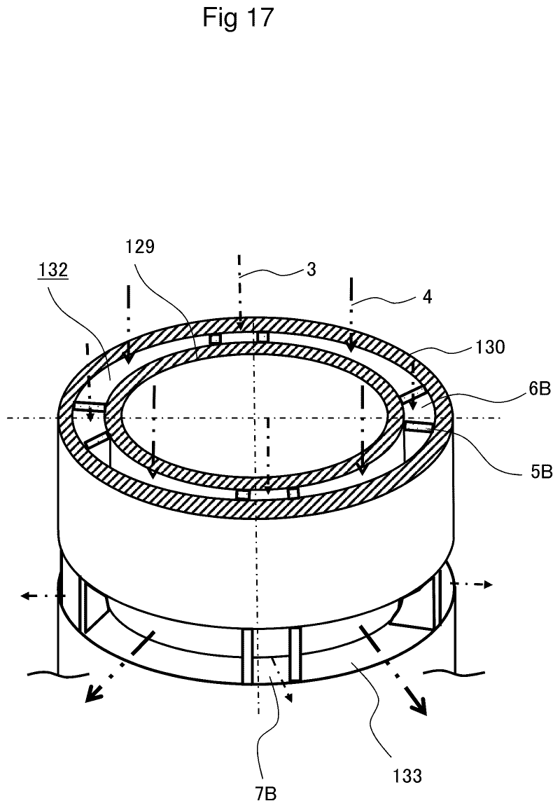

Further, as illustrated in FIG. 17, drainage ports 7B for the separated water are provided separately from the discharge ports for the steams. Thus, the water drained from the steam separator 105B is not raised by the steam. It is consequently possible to reduce a moisture content included in the steam rising from the outside of the steam separator 105B, that is, reduce a carry-over.

In addition, as illustrated in FIG. 13, regarding the third stage annular flow passage 138, the swirl speed within the third stage inner cylinder 135 is decreased, but as in the separating mechanism in the second stage, a swirling flow 145 also remains in the third stage annular flow passage 138. Therefore, the swirling flow 145 is used to make the steam collide with the vertical plates 31B installed within the third stage annular flow passage 138. A gas-water separation is thereby performed. By securing drainages 6C by the drainage forming plates 5C as illustrated in FIG. 15, and by providing drainage ports 7C for the water and discharge ports for the steam separately from each other, it is possible to reduce the droplets included in the steam, and reduce the carry-over of the fluid discharged to the outside of the steam separator 105B and flowing into the steam dryer 106.

Incidentally, as with the vertical plates 21 and 31 illustrated in FIG. 9 and FIG. 10, the drainage forming plates 5B and 5C can be implemented easily by being installed on the inner surfaces of the second stage outer cylinder 130 and the third stage outer cylinder 136 or the outer surfaces of the second stage inner cylinder 129 and the third stage inner cylinder 135. In addition, while the drainage forming plates 5B and 5C are preferably installed so as to be substantially in parallel with the vertical plates 21 and 31, the drainage forming plates 5B and 5C do not need to be substantially in parallel with the vertical plates 21 and 31. Further, the drainage forming plates 5B and 5C do not need to be installed at 90 degrees in the vertical direction with respect to the inner cylinders and the outer cylinders, but can be installed at an optional angle.

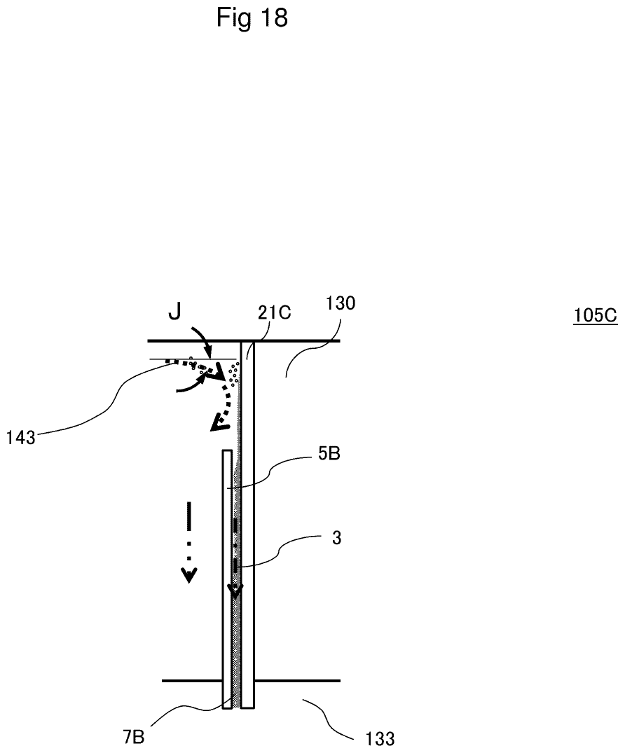

A first modification of the steam separator according to the second embodiment is illustrated in FIGS. 18 to 21.

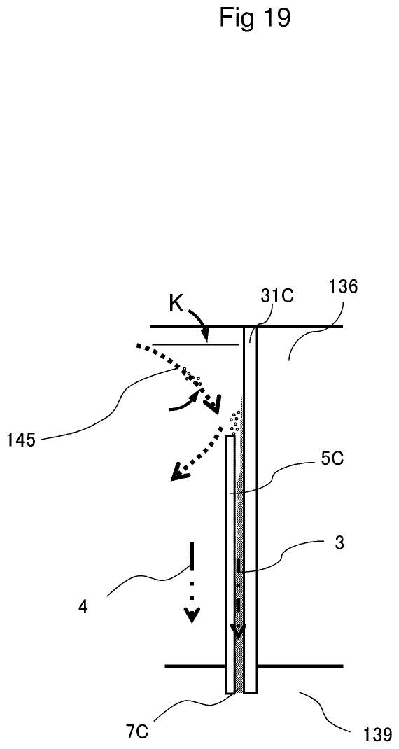

FIG. 18 is a developed view of a vertical plate and a drainage forming plate installed in the second stage annular flow passage in the second stage from the bottom when the inner surface of the second stage outer cylinder is viewed from the outer surface of the second stage inner cylinder. FIG. 19 is a developed view of a vertical plate and a drainage forming plate installed in the third stage annular flow passage in the third stage from the bottom of the steam separator when the inner surface of the third stage outer cylinder is viewed from the outer surface of the third stage inner cylinder. FIG. 18 and FIG. 19 also illustrate a difference between angles of collision of the steam with the vertical plates when the steam having swirl speeds collides with the vertical plates installed in the second stage annular flow passage and the third stage annular flow passage in FIG. 13.

In the steam separator 105C illustrated in FIG. 18, an angle K at which the steam within the third stage annular flow passage 138 in the third stage illustrated in FIG. 19 collides with a vertical plate 31C is larger than an angle J at which the steam within the second stage annular flow passage 132 in the second stage collides with a vertical plate 21C.

This is because the swirl speed occurring within the third stage annular flow passage 138 in the third stage is lower than the swirl speed occurring within the second stage annular flow passage 132 in the second stage. Thus, the axial direction length of the surface with which the steam collides needs to be lengthened in the third stage annular flow passage 138 in the third stage in which flow passage the swirl speed is low. Lengthening the length of the surface with which the steam collides increases, a possibility of being in contact with the descending steam at a time of an output power enhancement in which the steam flow rate is increased. Therefore, the surface with which the steam collides is preferably as short as possible.

Accordingly, the same effect can be obtained with the length of the vertical plates 21C installed in the second stage annular flow passage 132 in the second stage when the steam is made to collide with the vertical plate 31C before the angle K at which the steam within the third stage annular flow passage 138 in the third stage collides with the vertical plate 31C is increased, that is, at a point in time that the collision angle is small.

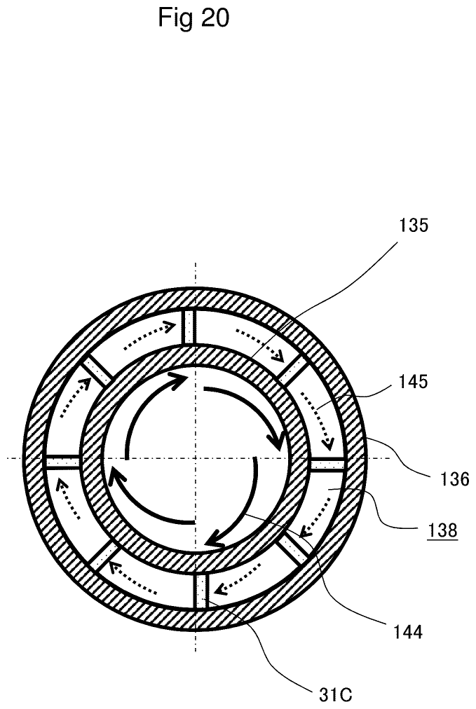

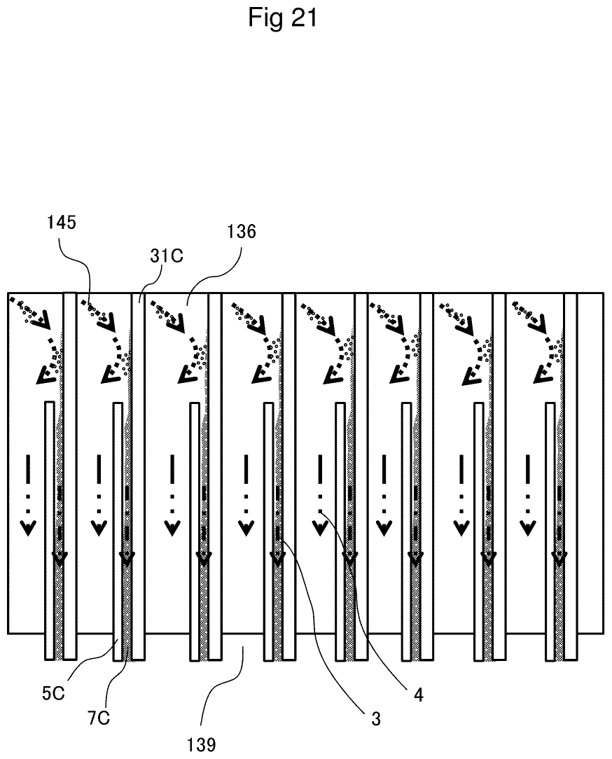

Conceivable as a method for realizing this is to make the numbers of vertical plates 21C and 31C differ from each other. FIG. 20 and FIG. 21 illustrate a structure in which the vertical plates are increased.

When the number of vertical plates 31C in the separating mechanism in the third or subsequent stage is made to be equal to or more than the number of vertical plates 21C in the separating mechanism on the lower stage side, as illustrated in FIG. 20 and FIG. 21, the axial direction lengths of the surfaces with which the steam collides with the vertical plates 21C and 31C installed in the second stage annular flow passage 132 in the second stage and the third stage annular flow passage 138 in the third stage are made to be appropriate lengths suitable for the flow directions of the steam flowing into the respective flow passages, so that the droplets in the steam can be removed more efficiently.

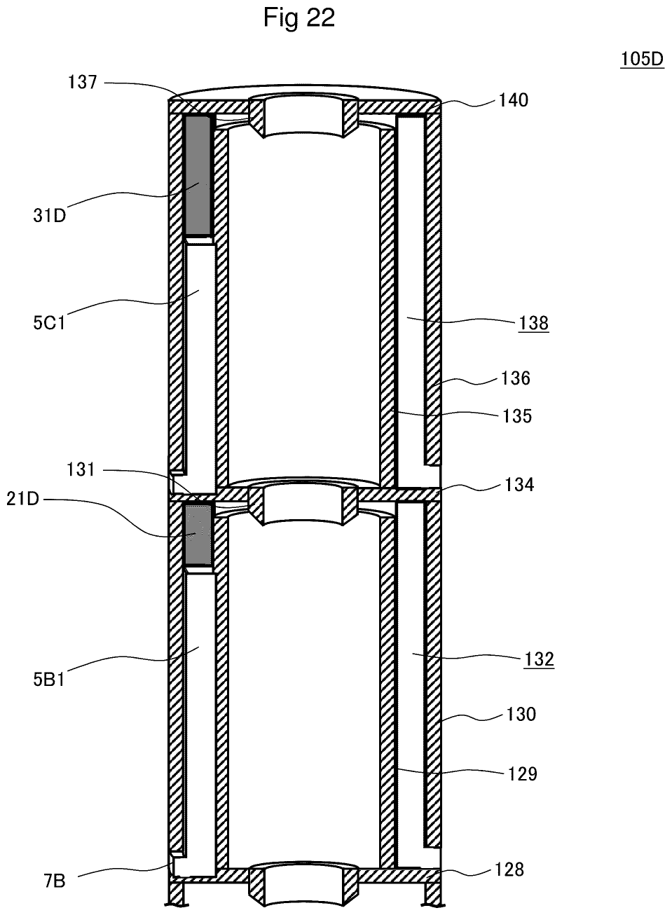

A second modification of the steam separator according to the second embodiment is illustrated in FIGS. 22 to 24.

A characteristic of a steam separator 105D according to the second modification of the present second embodiment lies in that the length of the vertical plates 21D installed in the second stage annular flow passage 132 is longer than the length of the vertical plates 31D installed in the third stage annular flow passage 138 of the steam separator 105D, and thereby a difference between the vertical direction length of vertical plates 31D and the vertical direction length of the drainage forming plates 5C1 in the separating mechanism in the third or subsequent stage is made to be equal to or more than a difference between the vertical direction length of vertical plates 21D and the vertical direction length of the drainage forming plates 5B1 on the lower stage side.

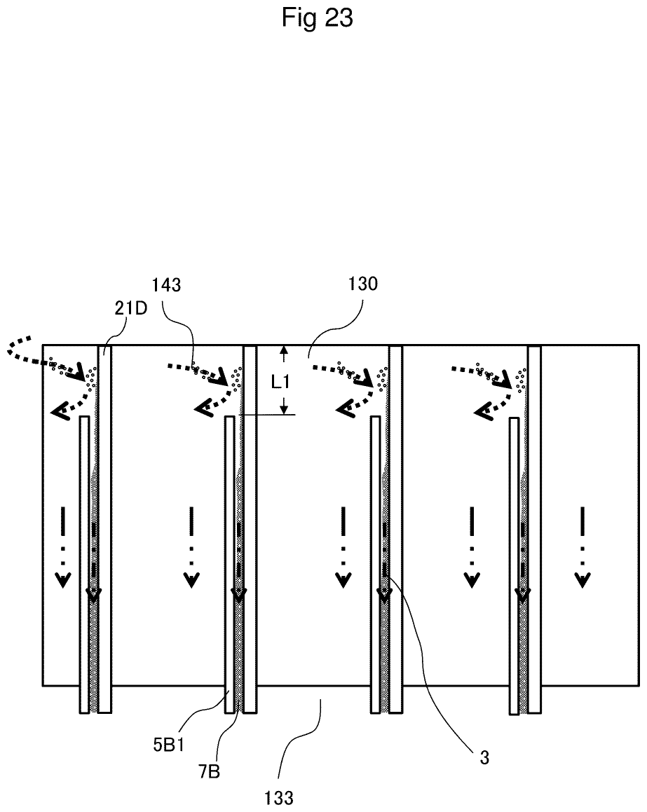

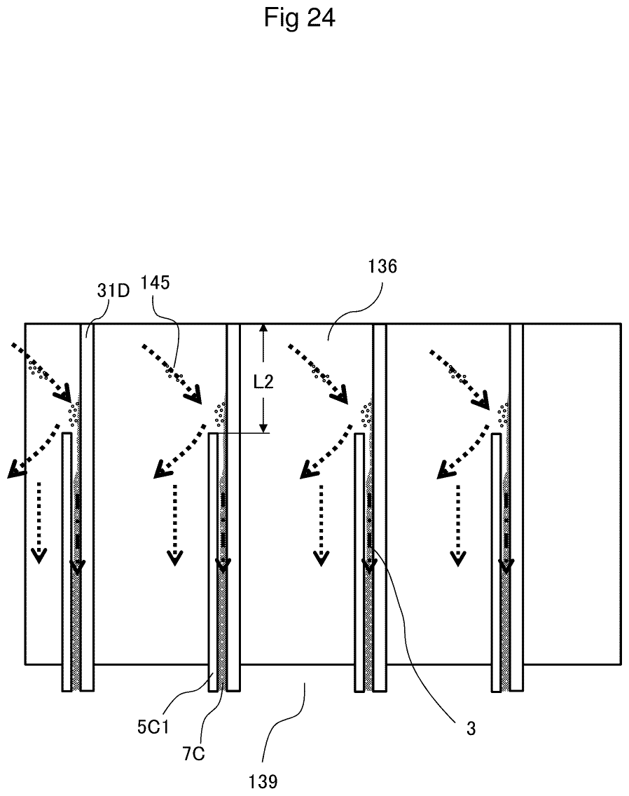

FIG. 23 illustrates a developed view of the vertical plates 21D and the drainage forming plates 5B1 installed in the second stage annular flow passage 132 of the steam separator 105D when the inner surface of the second stage outer cylinder 130 is viewed from the outer surface of the second stage inner cylinder 129. FIG. 24 illustrates a developed view of the vertical plates 31D and the drainage forming plates 5C1 installed in the third stage annular flow passage 138 of the steam separator 105D when the inner surface of the third stage outer cylinder 136 is viewed from the outer surface of the third stage inner cylinder 135.

As illustrated in FIG. 23 and FIG. 24, the length of the drainage forming plates 5B1 installed in the second stage annular flow passage 132 is made longer as compared with the drainage forming plates 5C1 installed in the third stage annular flow passage 138. The lengths of the surfaces on which the steam having the swirl speeds collides with the vertical plates 21D and 31D are L1 for the vertical plates 21D within the second stage annular flow passage 132 in the second stage and L2 longer than L1 for the vertical plates 31D within the third stage annular flow passage 138 in the third stage. Consequently, a probability of making the steam collide with the vertical plates 31D can be made higher as compared with a probability of making the steam collide with the vertical plates 21D. Further, the droplets in the steam can be removed efficiently.

Other configurations and operations are substantially the same as the configurations and the operations of the steam separator and the boiling water reactor including the same according to the foregoing first embodiment, and details thereof will be omitted.

The steam separator and the boiling water reactor including the same according to the foregoing first embodiment also provide effects substantially similar to those of the steam separator and the boiling water reactor including the same according to the second embodiment of the present invention.

In addition, the discharging of the droplets to the outside of the steam separator 105B, 105C, or 105D can be performed reliably by the further inclusion of the drainage forming plates 5B and 5C having a shorter length than the vertical plates 21B, 31B, 21C, 31C, 21D, and 31D at positions squarely facing the surfaces of the vertical plates 21B, 31B, 21C, 31C, 21D, and 31D with which surfaces the mixed flow collides.

Further, the vertical plates 21B, 31B, 21C, 31C, 21D, and 31D and the drainage forming plates 5B and 5C extend to the second stage discharge port 133 and the third stage discharge port 139 to respectively form the drainage ports for draining the water that adheres to the vertical plates 21B, 31B, 21C, 31C, 21D, and 31D and flow down as liquid films, and the exhaust ports for the steam. Thus, the discharging of the droplets to the outside of the steam separator 105B, 105C, or 105D can be performed more efficiently.

In addition, the number of vertical plates 31C in the separating mechanism in the third or subsequent stage is equal to or more than the number of vertical plates 21C in the separating mechanism on the lower stage side, or the difference between the vertical direction length of the vertical plates 31D and the vertical direction length of the drainage forming plates 5C in the separating mechanism in the third or subsequent stage is equal to or more than the difference between the vertical direction length of the vertical plates 21D and the vertical direction length of the drainage forming plates 5B on the lower stage side. Thus, a probability of making the steam collide with the vertical plates 21C, 21D, 31C, and 31D can be made higher, and the removal of the droplets in the steam can be performed more efficiently.

### Third Embodiment

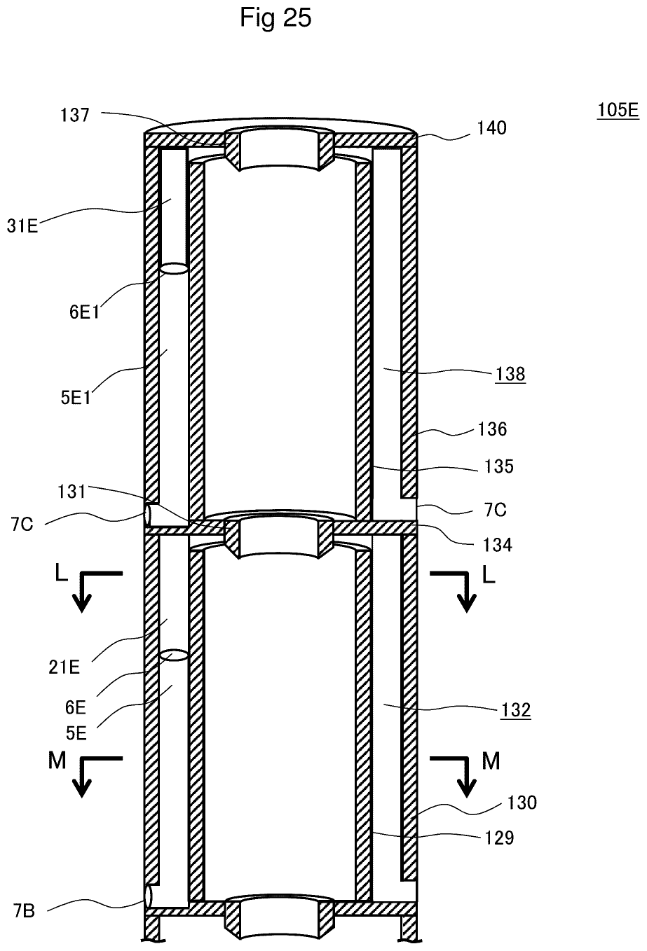

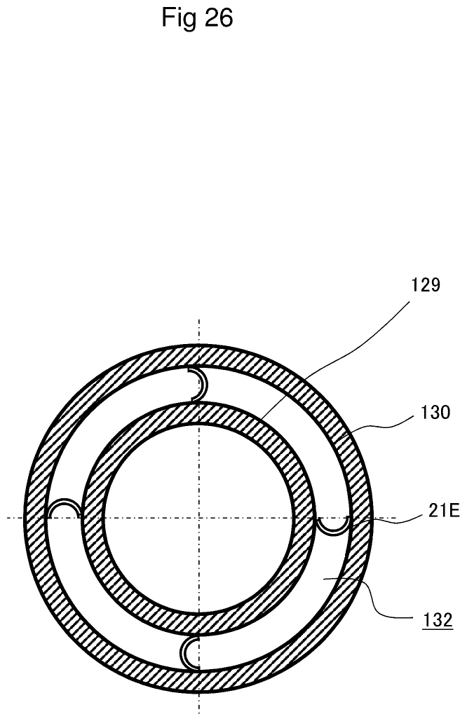

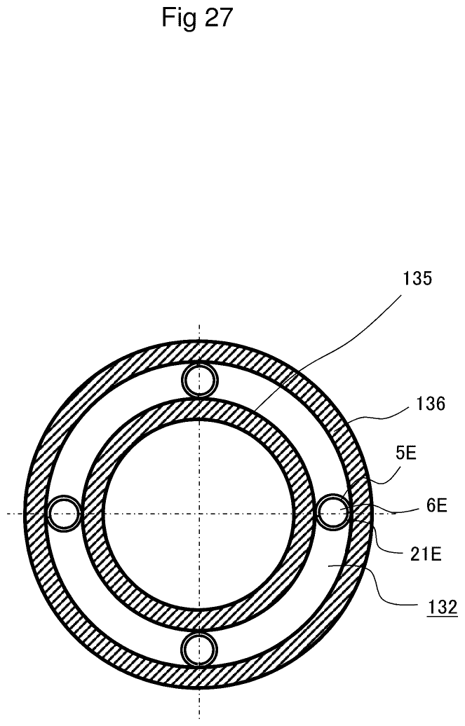

A steam separator and a boiling water reactor including the same according to a third embodiment of the present invention will be described with reference to FIGS. 25 to 27.

In a steam separator 105E according to the present embodiment illustrated in FIGS. 25 to 27, the structure of vertical plates 21E and 31E is a semicircular tube, and drainages have a circular tube structure.

The vertical plates formed as the vertical plates 21E and 31E in the shape of a semicircular tube as illustrated in horizontal sections of FIGS. 25 to 27 can prevent the scattering of the droplets more than the vertical plates 21, 21A, 21B, 21C, 21D, 31, 31B, 31C, and 31D in the shape of a flat plate as illustrated in the first embodiment and the second embodiment, when the steam including swirl components collides with the vertical plates 21E and 31E in the shape of a semicircular tube.

In addition, drainages 6E formed by spaces between semicircular drainage forming plates 5E and the vertical plates 21E are made to have a circular tube structure by further providing the drainage forming plates 5E. The drainages can be thereby realized easily. Incidentally, the drainage forming plates 5E do not need to be semicircular, but may be in the shape of a flat plate.

Similarly, drainages 6E1 are preferably formed by providing drainage forming plates 5E1 in the shape of a semicircle or in the shape of a flat plate within the third stage annular flow passage 138.

Other configurations and operations are substantially the same as the configurations and the operations of the steam separator and the boiling water reactor including the same according to the foregoing first embodiment, and details thereof will be omitted.

The steam separator and the boiling water reactor including the same according to the third embodiment of the present invention also provide effects substantially similar to those of the steam separator and the boiling water reactor including the same according to the foregoing first embodiment.

### Others

It is to be noted that the present invention is not limited to the foregoing embodiments, but includes various modifications. The foregoing embodiments are described in detail to describe the present invention in an easily understandable manner, and are not necessarily limited to embodiments including all of the described configurations.

In addition, a part of a configuration of a certain embodiment can be replaced with a configuration of another embodiment, and a configuration of another embodiment can be added to a configuration of a certain embodiment. In addition, for a part of a configuration of each embodiment, addition of another configuration, deletion, or substitution is possible.

For example, all of the foregoing embodiments illustrate a mode in which the vertical plates 21, 21A, 21B, 21C, 21D, 21E, 31, 31B, 31C, 31D, and 31 are extended in a straight line in the vertical direction. However, there is no limitation to this mode. The vertical plates can be installed in a direction substantially parallel with or substantially perpendicular to the mixed flow. Incidentally, when the vertical plates are installed in a direction substantially parallel with or substantially perpendicular to the mixed flow, parts close to the discharge ports are preferably extended in a straight line in the vertical direction in order to guide the liquid films to the discharge ports smoothly. Also in this case, drainage forming plates can be provided as appropriate.

### DESCRIPTION OF REFERENCE NUMERALS

2: Liquid film formed so as to adhere to a vertical plate
3: Downward flow of a liquid film
4: Downward flow of steam
5B, 5B1, 5C, 5C1, 5E, 5E1: Drainage forming plate
6B, 6C, 6E, 6E1: Drainage
7B, 7C: Drainage port
21, 21A, 21B, 21C, 21D, 21E: Vertical plate (second stage)
31, 31B, 31C, 31D, 31E: Vertical plate (third stage)
100: Advanced boiling water reactor
101: Nuclear reactor pressure vessel
102: Reactor core shroud
103: Reactor core
104: Shroud head
105, 105A, 105B, 105C, 105D, 105E: Steam separator
106: Steam dryer
108: Reactor core support plate
109: Fuel support fittings
110: Control rod guide tube
111: Control rod driving mechanism
113: Internal pump
114: Downcomer
115: Main steam pipe
116: Water supply pipe
117: Impeller
118: Coolant
119: Upper portion grid plate
120: Stand pipe
121: Diffuser
122: Swirler
123: First stage inner cylinder
124: First stage outer cylinder
125: First stage pickoff ring
126: First stage annular flow passage
127: First stage discharge port
128: First stage annular plate
129: Second stage inner cylinder (second or subsequent stage inner cylinder)
130: Second stage outer cylinder (second or subsequent stage outer cylinder)
131: Second stage pickoff ring (second or subsequent stage pickoff ring)
132: Second stage annular flow passage (second or subsequent stage annular flow passage)
133: Second stage discharge port (second or subsequent stage discharge port)
134: Second stage annular plate (second or subsequent stage annular plate)
135: Third stage inner cylinder (second or subsequent stage inner cylinder)
136: Third stage outer cylinder (second or subsequent stage outer cylinder)
137: Third stage pickoff ring (second or subsequent stage pickoff ring)
138: Third stage annular flow passage (second or subsequent stage annular flow passage)
139: Third stage discharge port (second or subsequent stage discharge port)
140: Third stage annular plate (second or subsequent stage annular plate)
141: Inter steam separator flow passage
142: Swirling flow within the second stage inner cylinder
143: Swirling flow within a second stage outer annular flow passage
144: Swirling flow within the third stage inner cylinder
145: Swirling flow within a third stage outer annular flow passage

What is claimed is:

1. A steam separator comprising: a plurality of stages of separating mechanisms,
a separating mechanism in a first stage from a bottom including
a stand pipe that guides a mixed fluid of steam generated by a reactor core and water upward from below,
a diffuser that communicates with an upper side end surface of the stand pipe to form a flow passage, and expands a flow passage cross-sectional area toward an upward direction more than a flow passage cross-sectional area of the upper side end surface,
a first stage inner cylinder that communicates with an upper side end surface of the diffuser to form a flow passage,
a swirler that includes a hub passing through an axial center of the flow passage of a mixed flow of the steam and the water and a plurality of swirl vanes attached radially with the hub as a center, the swirl vanes having an inner edge fixed to the hub in a radial direction of the swirl vanes, and having an outer edge fixed to an inner wall of the diffuser or an inner wall of the first stage inner cylinder in the radial direction of the swirl vanes,
a first stage outer cylinder that forms a first stage discharge port in a lower part of a first stage annular flow passage formed so as to be concentrically spaced from and surround the first stage inner cylinder,
a first stage annular plate that covers an upper side surface of the first stage outer cylinder, and forms a circular hole having a smaller diameter than the first stage inner cylinder, and
a first stage pickoff ring that is extended downward in a tubular shape from an inner circumferential edge forming the circular hole of the first stage annular plate, and forms the circular hole as a short flow passage to a second stage inner cylinder, and
a separating mechanism in a second or subsequent stage from the bottom including
a second or subsequent stage inner cylinder that is installed on the annular plate in a preceding stage to form a flow passage,
a second or subsequent stage outer cylinder that forms a second or subsequent stage discharge port in a lower part of a second or subsequent stage annular flow passage formed so as to be concentrically spaced from and surround the second or subsequent stage inner cylinder,
a second or subsequent stage annular plate that covers an upper side surface of the second or subsequent stage outer cylinder, and forms a circular hole having a smaller diameter than the second or subsequent stage inner cylinder, and
a second or subsequent stage pickoff ring that is extended downward in a tubular shape from an inner circumferential edge forming the circular hole of the second or subsequent stage annular plate, and forms the circular hole as a short flow passage to an inner cylinder in a next or subsequent stage or an outlet flow passage,
the separating mechanism in the second or subsequent stage including a vertical plate that divides the second or subsequent stage annular flow passage in a circumferential direction and eliminates a swirl component of the mixed flow continuously occurring from the second or subsequent stage inner cylinder to the second or subsequent stage annular flow passage.

2. The steam separator according to claim 1, wherein
the vertical plate is installed such that an end surface in a vertical direction of the vertical plate is at an angle of 90 degrees with respect to an outer surface of the second or subsequent stage inner cylinder and an inner surface of the second or subsequent stage outer cylinder.

3. The steam separator according to claim 1, wherein
the vertical plate is installed such that an end surface in a vertical direction of the vertical plate is at an angle smaller than 90 degrees or an angle larger than 90 degrees with respect to an outer surface of the second or subsequent stage inner cylinder and an inner surface of the second or subsequent stage outer cylinder.

4. The steam separator according to claim 1, wherein
the vertical plate is installed so as to be connected to an inner surface of the second or subsequent stage outer cylinder or an outer surface of the second or subsequent stage inner cylinder.

5. The steam separator according to claim 1, wherein
the vertical plate extends to the second or subsequent stage discharge port.

6. The steam separator according to claim 1, further comprising:
a drainage forming plate having a length shorter than the vertical plate at a position squarely facing a surface with which the mixed flow collides, the surface being included in the vertical plate.

7. The steam separator according to claim 6, wherein
the vertical plate and the drainage forming plate extend to the second or subsequent stage discharge port, and respectively form a drainage port for draining water adhering to the vertical plate and flowing down as a liquid film and an exhaust port for the steam.

8. The steam separator according to claim 1, wherein
number of vertical plates in the separating mechanism in a third or subsequent stage is equal to or more than number of vertical plates in the separating mechanism in a lower stage side of the separating mechanism in the third or subsequent stage.

9. The steam separator according to claim 6, wherein
a difference between a vertical direction length of the vertical plate and a vertical direction length of the drainage forming plate in the separating mechanism in a third or subsequent stage is equal to or more than a difference between a vertical direction length of the vertical plate and a vertical direction length of the drainage forming plate on a lower stage side of the separating mechanism in the third or subsequent stage.

10. A boiling water reactor comprising:
a nuclear reactor pressure vessel;
a reactor core that is provided within the nuclear reactor pressure vessel, and is loaded with a plurality of fuel assemblies;
a shroud in which the reactor core is disposed;
a steam separator that is disposed above the reactor core, and separates a mixed flow of steam generated by the reactor core and water into the steam and the water;
a steam dryer that is located above the steam separator, and dries wet steam separated by the steam separator;
a main steam pipe that supplies the steam dried by the steam dryer to a turbine;
a downcomer that is formed between the nuclear reactor pressure vessel and the shroud, and through which the water separated by the steam separator circulates; and
a pump that is disposed below the downcomer, and supplies the water within the downcomer to the reactor core, the steam separator being the steam separator according to claim 1.
